(19) United States
(12) Patent Application Publication
(10) Pub. No.: US 2024/0034636 A1
(43) Pub. Date: Feb. 1, 2024

(54) AMORPHOUS BORON NITRIDE COMPOUND, BORON NITRIDE FILM INCLUDING THE SAME, AND ELECTRONIC DEVICE INCLUDING THE BORON NITRIDE FILM

(71) Applicants: Samsung Electronics Co., Ltd., Suwon-si (KR); FUNDACIO INSTITUT CATALA DE NANOCIENCIA I NANOTECNOLOGIA (ICN2), Bellaterra (ES)

(72) Inventors: Stephan ROCHE, Barcelona (ES); Aleandro ANTIDORMI, Barcelona (ES); Onurcan KAYA, Barcelona (ES); Van Luan NGUYEN, Suwon-si (KR); Hyeonjin SHIN, Suwon-si (KR); Taejin CHOI, Suwon-si (KR); Jaewon KIM, Suwon-si (KR); Taehoon KIM, Suwon-si (KR)

(73) Assignees: Samsung Electronics Co., Ltd., Suwon-si (KR); FUNDACIO INSTITUT CATALA DE NANOCIENCIA I NANOTECNOLOGIA (ICN2), Bellaterra (ES)

(21) Appl. No.: 18/359,985

(22) Filed: Jul. 27, 2023

Related U.S. Application Data
(60) Provisional application No. 63/392,561, filed on Jul. 27, 2022.

(30) Foreign Application Priority Data
Jul. 26, 2023 (KR) 10-2023-0097473

(51) Int. Cl. C01B 35/14

(52) U.S. Cl. CPC C01B 35/146; C01P 2002/02; C01P 2002/54

(57) ABSTRACT

An amorphous boron nitride compound may include a boron nitride compound, where the boron nitride compound may be amorphous and may be doped with carbon or hydrogen. In the boron nitride compound, a total content of the carbon or the hydrogen may be in a range of about 0.1 at % to about 35 at % of a total atomic content.

### CROSS-REFERENCE TO RELATED APPLICATION

This application is based on and claims the benefit of U.S. Provisional Patent Application No. 63/392,561, filed on Jul. 27, 2022 in the United States Patent and Trademark Office, and Korean Patent Application No. 10-2023-0097473, filed on Jul. 26, 2023 in Korean Intellectual Proposed Office, the entire disclosures of which are incorporated by reference herein.

### BACKGROUND

### 1. Field

The present disclosure relates to an amorphous boron nitride compound, a boron nitride film including the same, and an electronic device including the boron nitride film.

### 2. Description of the Related Art

Integrated circuits of various electronic apparatuses including field effect transistors, memory devices, display apparatuses, image sensors, and the like may be manufactured by combining and connecting semiconductors, conductors, and insulators. For example, integrated circuits of various electronic apparatuses may be manufactured by forming a plurality of unit elements on a substrate and then stacking an interlayer insulating film and lines thereon.

As the degree of integration of integrated circuits considerably increases, an interval between conductor patterns is gradually decreasing. Accordingly, parasitic capacitance between the conductor patterns may increase, resulting in degradation of the performance of electronic apparatuses. For example, parasitic capacitance may delay signal transmission in semiconductor devices. In order to reduce such parasitic capacitance, insulator materials having a relatively low dielectric constant have been proposed as interlayer insulating films.

### SUMMARY

Provided are an amorphous boron nitride compound having excellent mechanical properties and thermal stability, a boron nitride film including the same, and an electronic device including the boron nitride film.

Additional aspects will be set forth in part in the description which follows and, in part, will be apparent from the description, or may be learned by practice of the presented embodiments of the disclosure.

According to an embodiment, an amorphous boron nitride compound may include a boron nitride compound, the boron nitride compound being amorphous and doped with carbon or hydrogen, wherein a total content of the carbon or the hydrogen may be in a range of about 0.1 at % to about 35 at % of a total atomic content.

In some embodiments, the boron nitride compound may be doped with the carbon, and a content of the carbon may be in a range of about 10 at % to about 20 at % of the total atomic content of the boron nitride compound.

In some embodiments, the boron nitride compound may be doped with the carbon, and the carbon may participate in B—C bonds, N—C bonds, and C—C bonds. A number of the B—C bonds may be greater than a number of the N—C bonds and a number of the C—C bonds. A number of the B—C bonds may be less than the number of the B—N bonds.

In some embodiments, a ratio of sp² bonding to spa bonding included in the boron nitride compound may be in a range of about 2 to about 5 or about 2 to about 3.

In some embodiments, an average coordination number of atoms in the boron nitride compound doped with the carbon may be in a range of about 2.92 to about 3.05.

In some embodiments, the boron nitride compound may be doped with the carbon and may have a density of more than about 2.18 g/cm³ to about 2.21 g/cm³.

In some embodiments, the boron nitride compound may be doped with the carbon and may have a diffusivity of 1 Å²/ns or less at a temperature of about 2,000 K to about 2,500 K.

In some embodiments, the boron nitride compound may be doped with the carbon, and a Young's modulus, a bulk modulus, and a shear modulus of the boron nitride compound may each independently be in a range of about 110% to about 140% as compared with an other boron nitride compound that is not doped with carbon.

In some embodiments, the boron nitride compound may be doped with the hydrogen. A content of the hydrogen may be in a range of about 5 at % to about 20 at % or about 8 at % to about 12 at % of the total atomic content of the boron nitride compound.

In some embodiments, the hydrogen may participate in B—H bonds, N—H bonds, and C—H bonds.

In some embodiments, the boron nitride compound may be doped with hydrogen and may have a diffusivity of 2 Å²/ns or less at a temperature of about 2,000 K to about 2,500 K.

In an embodiment, the boron nitride compound may be doped with the hydrogen and a Young's modulus, a bulk modulus, and a shear modulus of the boron nitride compound may each independently be in a range of about 110% to about 140% as compared with a boron nitride compound which is not doped with hydrogen.

According to an embodiment, a boron nitride material may include the above-described amorphous boron nitride compound.

In another embodiment, a boron nitride material may consist of the above-described amorphous boron nitride compound.

According to an embodiment, a boron nitride film may include the above-described amorphous boron nitride compound.

According to an embodiment, an electronic device may include the above-described boron nitride film. The electronic device may include an image sensor, a field effect transistor, a memory device, or a display device.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows graphs of radial distribution functions (RDFs) of samples of α-BN:C using ab-initio and Gaussian approximation potential (GAP) molecular dynamics;

FIG. 2A shows images of ball-and-stick models of samples of α-BN:C according to a carbon concentration;

FIG. 2B is a graph of an RDF of samples of α-BN:C according to a carbon concentration;

FIG. 2C is an enlarged view of a main peak of the graph in FIG. 2B;

FIG. 3A is a graph of the chemical decomposition of a first peak of an RDF in samples of α-BN:C with a carbon concentration of 0 at %;

FIG. 3B is a graph of the chemical decomposition of a first peak of an RDF in samples of α-BN:C with a carbon concentration of 40 at %;

FIG. 4A is a graph showing an average coordination number of atoms of samples of α-BN:C according to a carbon concentration;

FIG. 4B is a graph showing a ratio of the number of sp²-hybridized atoms to the number of spa-hybridized atoms of samples of α-BN:C according to a carbon concentration;

FIG. 5 is a graph showing the number of various bonds observed in samples of α-BN:C according to a carbon concentration;

FIG. 6 is a graph showing potential energy according to temperature of α-BN:C sample systems having different carbon concentrations;

FIG. 7 is a graph showing diffusivity of samples of α-BN:C according to a carbon concentration;

FIG. 8 is a graph showing diffusivity of samples of α-BN:H according to a hydrogen concentration;

FIG. 9 is a graph showing a Young's modulus, a bulk modulus, and a shear modulus according to a carbon concentration of samples of α-BN:C;

FIG. 10 is a graph showing a Young's modulus, a bulk modulus, and a shear modulus according to a hydrogen concentration of samples of α-BN:H;

FIG. 11 is a schematic cross-sectional view illustrating a structure of an image sensor according to an embodiment;

FIG. 12 is a schematic cross-sectional view of a structure of a semiconductor device including an interconnection structure, according to an embodiment;

FIG. 13 is a schematic cross-sectional view of a structure of a field effect transistor according to an embodiment;

FIG. 14 is a schematic cross-sectional view of a structure of a field effect transistor according to another embodiment; and

FIG. 15 is a view of a display device according to an embodiment.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list. For example, “at least one of A, B, and C,” and similar language (e.g., “at least one selected from the group consisting of A, B, and C”) may be construed as A only, B only, C only, or any combination of two or more of A, B, and C, such as, for instance, ABC, AB, BC, and AC.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

Hereinafter, as inventive concepts allow for various changes and numerous embodiments, specific embodiments will be illustrated in the drawings and described in detail in the written description. However, this is not intended to limit inventive concepts to particular modes of practice, and it is to be appreciated that all changes, equivalents, and substitutes that do not depart from the spirit and technical scope are encompassed in embodiments of inventive concepts.

The terms used herein are merely used to describe specific embodiments and are not intended to limit inventive concepts. An expression used in the singular encompasses the expression of the plural, unless it has a clearly different meaning in the context. As used herein, it is to be understood that the terms such as “including,” “having,” and “comprising” are intended to indicate the existence of the features, numbers, steps, actions, components, parts, ingredients, materials, or combinations thereof disclosed in the specification and are not intended to preclude the possibility that one or more other features, numbers, steps, actions, components, parts, ingredients, materials, or combinations thereof may exist or may be added.

In the drawings, the thicknesses of layers and regions are exaggerated or reduced for clarity. Like reference numerals in the drawings denote like elements throughout the specification. Throughout the specification, it will be understood that when a component, such as a layer, a film, a region, or a plate, is referred to as being “on” another component, the component may be directly on the other component or intervening components may be present thereon. Throughout the specification, while such terms as “first,” “second,” and the like may be used to describe various components, such components should not be limited to the above terms. The above terms are used only to distinguish one component from another.

In addition, hereinafter, an apparatus of an embodiment of the disclosure will be described in detail with reference to the accompanying drawings. Like reference numerals refer to like elements throughout. In the drawings, the size of each element may be exaggerated for clarity and for convenience of description. Embodiments set forth herein are merely examples and various changes may be made therein.

Hereinafter, an expression such as “above” or “on” may include not only the meaning of immediately “on” in a contact manner, but also the meaning of “on” in a non-contact manner. A singular form may include a plural form if there is no clearly opposite meaning in the context. In addition, throughout the specification, unless explicitly described to the contrary, the word “comprise” and variations such as “comprises” or “comprising” will be understood to imply the inclusion of stated elements but not the exclusion of any other elements.

The use of the terms “a and “an” and “the and similar referents in the context of describing the embodiments (especially in the context of the following claims) are to be construed to cover both the singular and the plural. The operations of all methods described herein can be performed in any suitable order unless otherwise indicated herein or otherwise clearly contradicted by context.

Hereinafter, the term “ . . . unit,” “ . . . module,” or the like implies a unit of processing at least one function or operation and may be implemented in hardware or software or in combination of the hardware and the software.

Also, the connection lines or connection members between elements shown in the drawings represent example functional connections and/or physical or logical connections, and may be presented as various alternative or additional functional connections, physical connections, or logical connections in a practical apparatus.

All of the examples or example terms (for example, etc.) are simply used to describe the technical idea in detail, and the range is not limited by the above-described examples or example terms as long as they are not limited by the claims.

As used herein, “boron nitride compound” refers to a compound of a chemical formula of BN or material which is consisted thereof (e.g., formed thereof). The material may have for example the form of powder, film and etc. Hydrogen and/or carbon dopants (e.g., hydrogen and/or carbon atoms) may be added to the boron nitride compound.

As used herein, “amorphous boron nitride compound” refers to an amorphous boron nitride compound and is also expressed as α-BN.

As used herein, “α-BN:C” refers to a carbon-doped amorphous boron nitride compound, and “α-BN:H refers to a hydrogen-doped amorphous boron nitride compound.

(Amorphous Boron Nitride Compound)

An amorphous boron nitride compound according to an aspect will be described in detail.

The amorphous boron nitride compound may be doped with carbon atoms or hydrogen atoms. The total content of carbon atoms or hydrogen atoms may be in a range of about 0.1 atomic % to about 35 atomic % of the total atomic content. In an embodiment, the amorphous boron nitride compound may have a carbon atom content of about 0.1 at % to about 35 at %, for example, about 10 at % to about 30 at %, for example, about 10 at % to about 20 at %, or for example, about 15 at % to about 20 at % with respect to the total amount.

The doped carbon atom may participate in a B—C bond, an N—C bond, or a C—C bond in the amorphous boron nitride compound.

In an embodiment, the number of B—C bonds may be greater than the number of N—C bonds and the number of C—C bonds. In an embodiment, the number of B—C bonds may be less than the number of B—N bonds.

In an embodiment, sp³ bonding of a B—C bond, an N—C bond, or a C—C bond may be included in addition to sp² bonding of B—N by the carbon atom doped in the amorphous boron nitride compound.

In an embodiment, a ratio of the sp² bonding to the sp³ bonding included in the amorphous boron nitride compound having a carbon content in above range may be in a range of about 2 to about 5 or about 2 to about 3. An average coordination number of atoms in the boron nitride compound having a carbon content in above range may be in a range of about 2.92 to about 3.05 or about 3.00 to about 3.05 or about 3.02 to about 3.05. That is, the average coordination number of atoms may be an average coordination number of B atoms, N atoms, and C atoms in the amorphous boron nitride compound.

The amorphous boron nitride compound having a carbon content in the above range may have a density of about 1.9 g/cm³ to about 2.5 g/cm³ or about 2.0 g/cm³ to about 2.3 g/cm³ or about 2.1 g/cm³ to about 2.3 g/cm³. For example, amorphous boron nitride compound may have a density of about 2.18 g/cm³ to about 2.22 g/cm³ or about 2.19 g/cm³ to about 2.21 g/cm³.

Atoms in the amorphous boron nitride compound having a carbon content in the above range may have a diffusivity of 1 Å²/ns or less at a temperature of about 2,000 K to about 2,500 K.

A Young's modulus, a bulk modulus, and a shear modulus of the boron nitride compound having a carbon content in the above range are each independently in a range of about 110% to about 140%, for example, about 115% to about 135% as compared with boron nitride compounds which are not doped with carbon atoms.

In an embodiment, the amorphous boron nitride compound may have a hydrogen atom content of about 0.1 at % to about 20 at %, for example, about 5 at % to about 20 at %, for example, about 8 at % to about 15 at %, or for example, about 8 at % to about 12 at % with respect to the total amount.

The doped hydrogen atom may participate in a B—H bond, an N—H bond, or a C—H bond in the boron nitride compound and the boron nitride compound may include spa bonding of a B—H bond, an N—H bond, or a C—H bond in addition to sp² bonding of B—N.

Atoms in the amorphous boron nitride compound having a hydrogen content in the above range may have a diffusivity of 2 Å²/ns or less or 1 Å²/ns less at a temperature of about 2,000 K to about 2,500 K.

A Young's modulus, a bulk modulus, and a shear modulus of the boron nitride compound having a hydrogen content in the above range are each independently in a range of about 105% to about 140%, for example, about 110% to about 140%, for example, about 110% to about 135% for example, for example, about 110% to about 130% as compared with boron nitride compounds which are not doped with hydrogen atoms.

In one embodiment, the amorphous boron nitride compound may be doped with both carbon atoms and hydrogen atoms and include the hydrogen content and the carbon content in the aforementioned range. The amorphous boron nitride compound having a carbon content and/or hydrogen content in the above range may have improved thermal stability and mechanical stability as shown in the diffusivity and elastic modulus. The improved thermal stability and mechanical stability of the amorphous boron nitride compounds are believed to be related to an increase in spa bonding due to carbon doping and/or hydrogen doping.

(Simulation)

Sample Design Method

In a Sample design method, research on thermal stability and mechanical properties of carbon- or hydrogen-doped amorphous boron nitride (α-BN:C or α-BN:H) is done using machine-learning and ab-initio techniques for classical molecular dynamics (CMD).

Atomistic calculations are applied in the framework of classical molecular dynamics, carried out within the large-scale atomic/molecular massively parallel simulator (LAMMPS) package for samples of carbon- or hydrogen-doped α-BN. For the samples of carbon- or hydrogen-doped α-BN, a new force-field is generated based on machine-learning methods, and interatomic forces are predicted in a large number of hydrogen atom configurations using potential energy which is a result of the force-field. In the present research, a Gaussian Approximation Potential (GAP) framework, which is based on the Gaussian process regression methodology, typically using the Smooth Overlap of Atomic Positions (SOAP) kernel, is used. In this case, a GAP model that is specially developed for α-BN is used.

The database is used to train the potential is as large as 10 000 different structures, each consisting of a system of 2 to 200 atoms. The resulting potential is validated by comparing the radial distribution functions (RDFs) of the potential of carbon- or hydrogen-doped α-BN at temperatures of 300 K and 5,000 K using the density functional theory (DFT) and GAP potential.

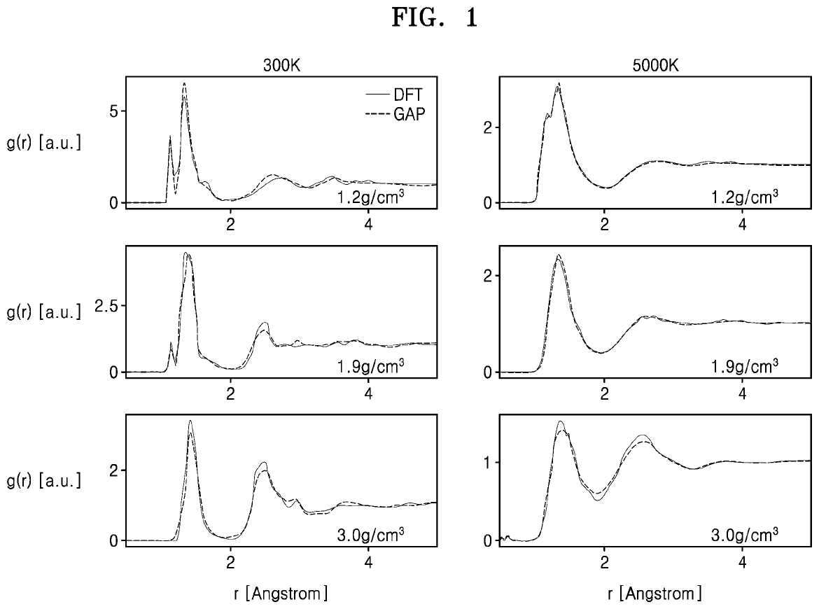

FIG. 1 shows graphs of RDFs of atomistic samples of carbon-doped amorphous boron nitride (α-BN:C) that are generated via a “quench-from melt” protocol using ab-initio (solid lines) and GAP molecular dynamics (MD) (dotted lines). To this end, calculations are performed on samples of α-BN with 200 atoms and a carbon content of 5 at %. Calculations are performed on densities of 1.2 g/cm³, 1.9 g/cm³, and 3.0 g/cm³ at temperatures of 300 K and 5,000 K, respectively. Referring to FIG. 1, it can be seen that GAP-MD simulations perfectly match DFT data at different temperatures and densities.

The generated potential energy is employed to explore a wide range of α-BN:C or α-BN:H structures using classical molecular dynamics. Specifically, generation of amorphous samples of α-BN:C with carbon concentrations of 5 at %, 10 at %, 20 at %, 30 at %, and 40 at % is simulated by the quenching “from-the-melt method” applied to randomly-generated atomistic configurations (containing 1,000 atoms) with a cubic shape (L=Lₓ=L_{y}=L_{z}≈21 Å). In addition, generation of amorphous samples of α-BN:H with hydrogen concentrations of 0 at %, 5 at %, 8 at %, 10 at %, 12 at %, 15 at %, and 20 at % is simulated. The size of systems is chosen to obtain a mass density close to an experimental value (2.1 g/cm³) and to be large enough to contain a reliable sampling of all possible bonds and atomic structures as present in real fabricated samples.

Structural Analysis

The structural characteristics of samples of α-BN:C with carbon concentrations of 0 at %, 5 at %, 10 at %, 20 at %, 30 at %, and 40 at %, respectively, are analyzed.

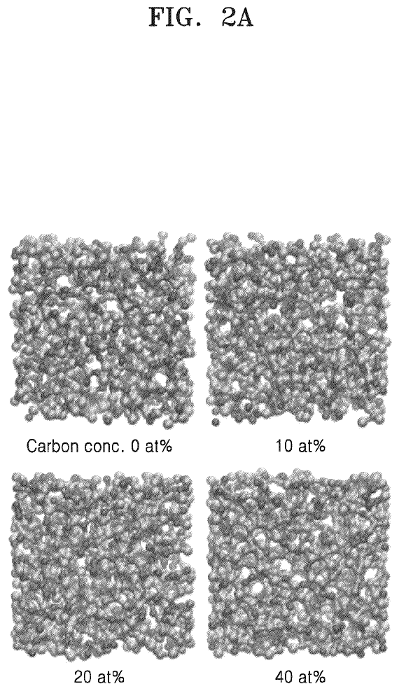

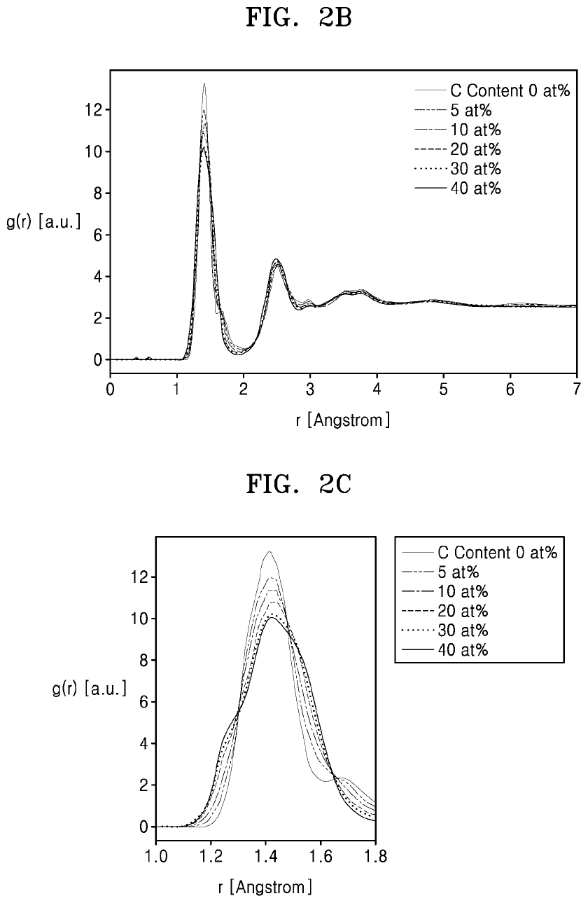

FIG. 2A shows images of ball-and-stick models of the samples of α-BN:C according to a carbon concentration. FIG. 2B is a graph of an RDF g(r) of the samples of α-BN:C according to a carbon concentration, and FIG. 2C is an enlarged view of a main peak in FIG. 2B.

Referring to FIG. 2B, all of the samples of α-BN:C with different carbon concentrations show clear and identifiable peaks for interatomic distances shorter than 5 Å. No peak can be identified at distances longer than 5 Å, which indicates that the samples have no long-range order in independently of a carbon concentration, that is, have no crystallinity and are amorphous. The short-range order in α-BN:C is in turn dominated by n first nearest-neighbor distances contributing to a first peak located at an average distance of about 1.42 Å (average B—N chemical bond length). Referring to 2C, a phenomenon in which, a doping concentration of carbon increases, the first peak is clearly broadens is observed. Such modification of this first peak is due to the formation of chemical bonds B—C, C—N, and C—C different from B—N due to carbon doping.

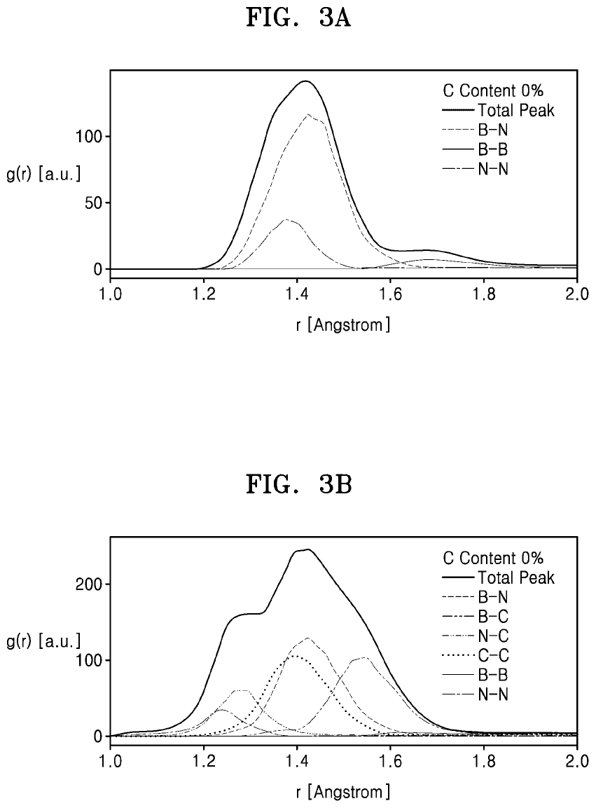

FIGS. 3A and 3B show the chemical decomposition of a first peak of an RDF in samples of α-BN:C with carbon concentrations of 0 at % and 40 at %. In comparison between FIG. 3A and FIG. 3B, it can be seen that new chemical bonds with an average length slightly different from that of B—N are formed due to the presence of carbon atoms. Referring to FIG. 3B, average lengths of B—C, C—N, and C—C bonds are found to be about 1.52 Å, about 1.3 Å, and about 1.40 Å, respectively. Consequently, the first peak is a convolution of peaks at different distances.

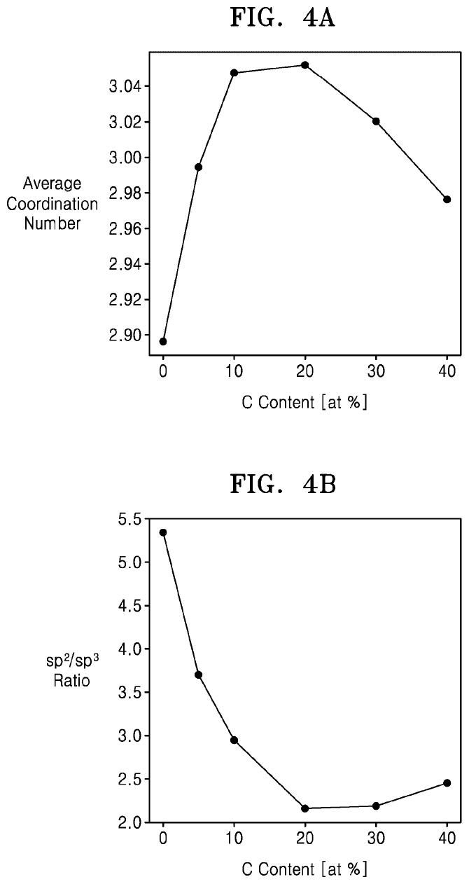

Meanwhile, the local characteristics of α-BN:C may be understood by considering an average coordination number in samples generated according to a carbon doping concentration. FIG. 4A is a graph showing an average coordination number of atoms of samples of α-BN:C versus a carbon content.

Referring to FIG. 4A, the average coordination number of atoms of the samples of α-BN:C is close to 3, which indicates that most of atoms are sp²-hybridized. In FIG. 4A, the average coordination number of atoms increases with carbon doping, reaches a maximum value when a carbon concentration is in a range of 15 at % to 20 at %, and then decreases as carbon doping increases. This indicates that, at a small doping concentration, atoms in the samples of α-BN:C favor a larger coordination number.

FIG. 4B is a graph showing a ratio of the number of sp²-hybridized atoms having a coordination number of 3 to the number of spa-hybridized atoms having a coordination number of 4. Referring to FIG. 4B, carbon doping in the samples of α-BN:C reduces a sp²/sp³ ratio, and a minimum of the sp²/sp³ ratio is observed around a carbon concentration of about 20 at %. Meanwhile, a density of the samples of α-BN:C slightly increases from 2.18 g/cm³ to 2.21 g/cm³ as a spa content increases.

By examining the number and type of chemical species that may be found in the samples as a function of carbon doping, a deeper understanding of a chemical composition of the samples may be obtained.

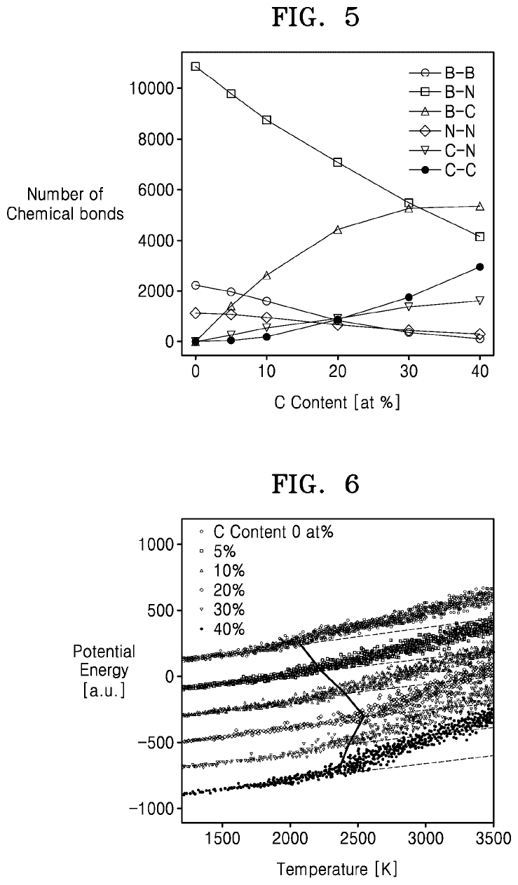

FIG. 5 is a graph showing the number of various bonds observed in samples of α-BN:C according to a carbon concentration. Referring to FIG. 5, while the total number of B—N bonds monotonically decreases according to carbon doping, the number of carbon-containing bonds gradually increases. Most of carbon in α-BN:C is bonded to B (B—C bond), of which an amount is equal to that of B—N bonds when a carbon concentration is 30 at %. Smaller concentrations are found for N—C and C—C bonds, increasing with doping.

Thermal Stability Analysis

In order to evaluate the thermal stability of α-BN:C, several MD calculations are performed using the validated GAP potential to extract an atoms mean squared displacement (MSD) and diffusivity D at various temperatures. The diffusivity D, that is, Cambria Math corresponds to the long-term behavior of MSD and is used to describe the mobility of atoms in solid and liquid phases of materials.

In particular, in a low-temperature region, the MSD tends to be a non-zero constant, while the diffusivity is zero. At higher temperatures, atomic positions of a material are rearranged, and thus a non-zero slope of the MSD is observed. From a comparison of diffusivity versus temperature of atomic samples, an insight may be obtained on an effect of carbon doping on the structural stability of α-BN:C. To this end, a heating process of samples consisting of a multi-step procedure is simulated. After the samples are equilibrated at a temperature of 300 K for 5 ps, the temperature is gradually modified by repeating the following steps: 1) the temperature is linearly increased with ΔT=50 K in 10 ps; and 2) the temperature is kept fixed in the following 50 ps. The above iterative scheme is repeated until a maximum temperature larger than 3,000 K is reached. Simulations are performed in a constant-temperature (NPT) ensemble with a Nose-Hover thermostat for temperature control and a time step of 0.25 fs.

During heating of samples of α-BN:C with different carbon concentrations, a time evolution of potential energy of the samples is investigated. To this end, the samples are slowly heated from ambient temperature (300 K) up to 3,500 K at a constant rate, and thus the potential energy is monitored. No qualitative change is observed when different heating rates are adopted.

FIG. 6 is a graph showing potential energy according to a temperature of α-BN:C sample systems having different carbon concentrations. The dotted lines in the graph of FIG. 6 show the linear fit extracted from the low-temperature range. Referring to FIG. 6, the potential energy of the systems increases linearly in a low temperature region, but a strong deviation from the linearity is observed in a high temperature region. A temperature at which the potential energy deviates from a linear trend observed in the low-temperature region may be considered as a parameter of the stability of a sample, and as the temperature is higher, the system is more structurally stable. As shown as a connecting line in FIG. 6, the temperature increases considerably for small amounts of carbon doping and reaches a maximum value at a carbon concentration of 10 at % to 20 at %. A further increase in carbon doping causes a decrease in stability, which is driven by an sp²/sp³ ratio which defines a structural shape of samples of α-BN:C.

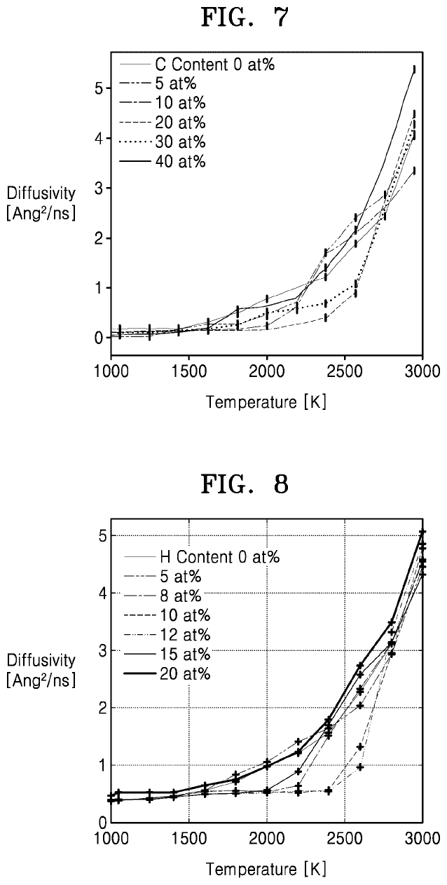

FIG. 7 is a graph showing computed diffusivity of atoms as a function of temperature for α-BN:C samples of a different carbon concentration. Each curve in FIG. 7 is an average of five runs, and a vertical bar denotes a corresponding error. Referring to FIG. 7, at low temperatures (up to about 1,500 K), diffusivity is zero (within statistical accuracy) for all the samples, which means that atomic positions do not change over time and are structurally stable. At temperatures higher than 1,500 K, thermal energy induces structural rearrangements of systems, leading to atomic diffusion. As a result, the diffusivity rapidly increases with temperature in a strongly non-linear fashion. In particular, the diffusivity of samples of α-BN:C with a carbon content of 10% to 20% is observed to be smaller than that of samples with other carbon concentrations up to a temperature of about 2,500 K. This points to stronger structural stability of the corresponding samples upon an increase in temperature. The samples of α-BN:C with a carbon content of 10 at % to 20 at % actually generally exhibit relatively low diffusivities even at a high temperature. The unstable system has diffusivity that is 3 times or more that of the most stable system at a temperature of 2,000 K.

FIG. 8 is a graph showing computed diffusivity of atoms as a function of temperature for α-BN:H samples of a different hydrogen concentration. Each curve in FIG. 8 is an average of five runs, and a vertical bar denotes a corresponding error. Referring to FIG. 8, at low temperatures (up to about 1,500 K), diffusivity is zero (within statistical accuracy) for all the samples, which means that atomic positions do not change over time and are structurally stable. At temperatures higher than 1,500 K, thermal energy induces structural rearrangements of systems, leading to atomic diffusion. As a result, the diffusivity rapidly increases with temperature in a strongly non-linear fashion. In particular, the diffusivity of samples of α-BN:H with a hydrogen content of 10% to 20% is observed to be smaller than that of samples with other hydrogen concentrations ups to a temperature of about 2,500 K. This means that the structural stability of the corresponding samples according to a temperature rise appears stronger. The samples of α-BN:H with a hydrogen content of 10 at % to 20 at % actually generally exhibit relatively low diffusivities even at a high temperature. The unstable system has diffusivity that is 10 times or more that of the most stable system at a temperature of 2,000 K.

Mechanical Properties

In the present research, additional short MD quenching is performed from 300 K to a very low temperature, and finally, a conjugate-gradient relaxation is performed to minimize a force applied to atoms. Cell vectors are kept fixed to keep the density unchanged. For each optimized structure, a full 6×6 matrix of elastic constants “C” is computed without imposing symmetry operations, and transformed into an inverse matrix to obtain a compliance matrix S.

By using the elastic constants of the matrix S, the mechanical stability and properties of α-BN:C and α-BN:H structures at different doping levels are investigated. In order to validate the mechanical stability of-BN:C and α-BN:H, whether the elastic constants satisfy the conditions is checked.

C₁₁-C₁₂>0, C₁₁>0, C₄₄>0, and C₁₁+2C₁₂>0.

At all doping levels, α-BN:C and α-BN:H satisfied the conditions, and thus the stability thereof is confirmed. After the stability of α-BN:C and α-BN:H is validated, elastic moduli are calculated using Voigt-Reuss-Hill approximation.

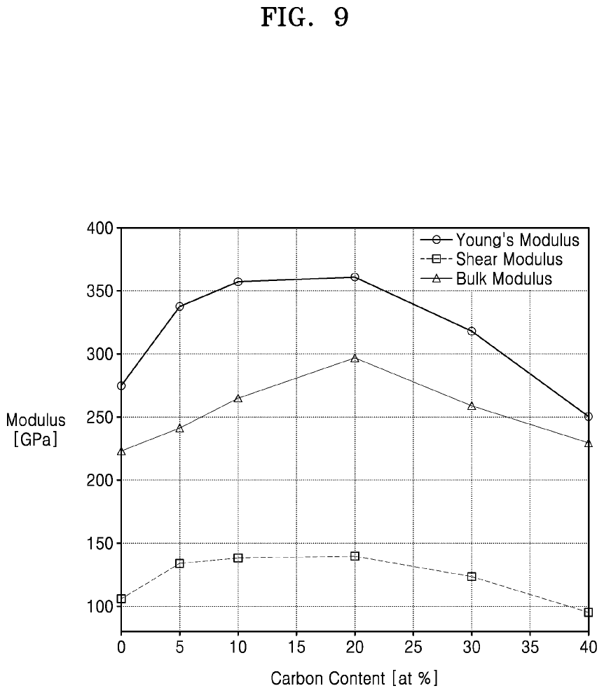

FIG. 9 is a graph showing a Young's modulus, a bulk modulus, and a shear modulus according to a carbon concentration of samples of α-BN:C. Referring to FIG. 9, all of the elastic moduli show maximum values at a doping of 10 at % to 20 at %, similar to thermal stability and density, and show lower values than those of an undoped sample at at %.

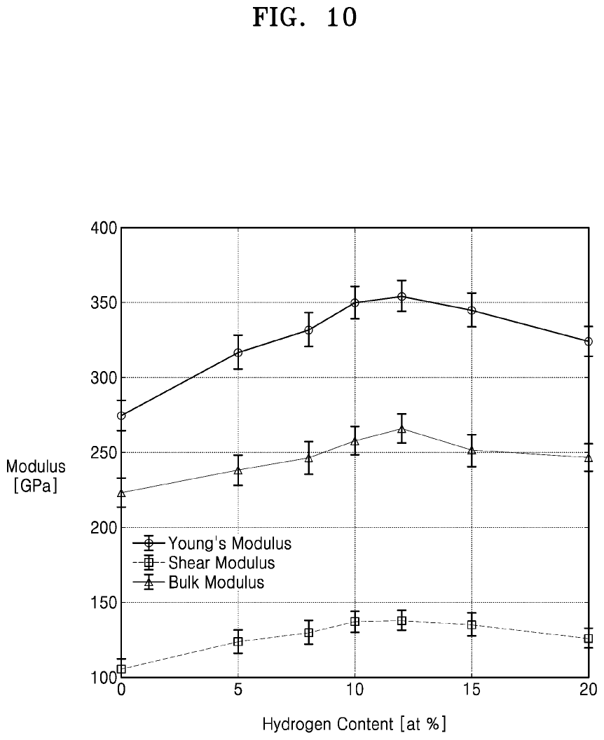

FIG. 10 is a graph showing a Young's modulus, a bulk modulus, and a shear modulus according to a hydrogen concentration of samples of α-BN:H. Referring to FIG. all of the elastic moduli show maximum values at a doping of 10 at % to 12 at %, similar to thermal stability and density.

From the above results, it can be seen that an sp³ ratio increases up to 20 at % of carbon doping in the samples of α-BN:C, and along with the sp³ ratio, thermal stability and density increase, and mechanical stability is also improved. In addition, it can be seen that the thermal stability and mechanical stability are improved up to 12 at % of hydrogen doping in the samples of α-BN:H and then are reduced at additional doping.

(Amorphous Boron Nitride Film)

An amorphous boron nitride film according to another aspect may be formed from the amorphous boron nitride compound according to the above-described embodiment.

The amorphous boron nitride film may be formed to have a thickness of, for example, about 1 nm to about 1000 nm, for example, about 1 nm to about 500 nm, or for example, about 1 nm to about 100 nm, for example, about 1 nm to about 50 nm, or for example, about 1 nm to about 20 nm, but is not limited thereto. The thickness of the amorphous boron nitride film may be adjusted while being less affected by electric field breakdown or the like due to dangling bonds or grain boundaries that are present when a film is crystalline. The amorphous boron nitride film may exhibit a low dielectric constant even with a thin thickness. The amorphous boron nitride film may have a dielectric constant of about 1.5 to about 4, for example, about 1.7 to about 3, or for example, about 1.8 to about 2.5. In addition, since the amorphous boron nitride film has thermal stability and mechanical stability at a high temperature, the amorphous boron nitride film may be applied to electronic devices to maintain reliability.

The boron nitride film may be formed, for example, through chemical vapor deposition (CVD).

The amorphous boron nitride film according to the embodiment of the disclosure may be applied to various electronic devices. For example, the amorphous boron nitride film according to the embodiment of the disclosure may be used as an interlayer insulating film, a diffusion barrier, a spacer, a device isolation film, or the like of various electronic devices including image sensors, field effect transistors, memory devices, displays, and the like.

(Electronic Device)

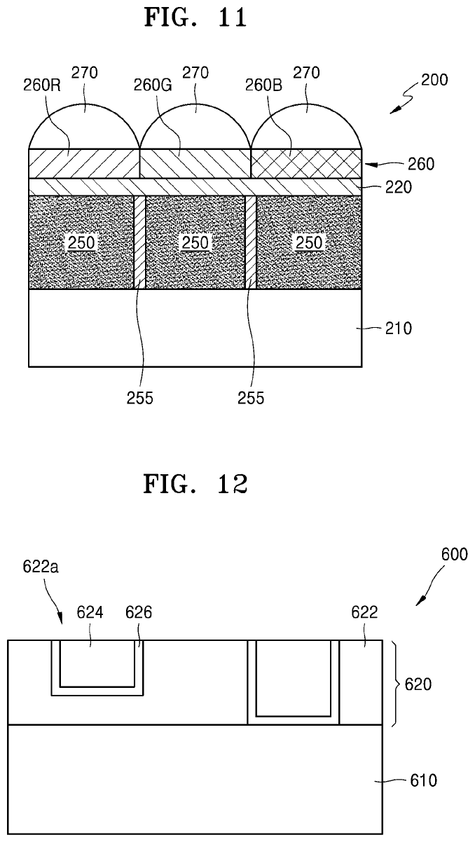

FIG. 11 is a schematic cross-sectional view illustrating a structure of an image sensor 200 according to an embodiment. Referring to FIG. 11, the image sensor 200 may include a substrate 210, a plurality of photodiodes 250 provided on the substrate 210, an amorphous boron nitride film 220 provided on the plurality of photodiodes 250, and a color filter layer 260 provided on the amorphous boron nitride film 220.

The plurality of photodiodes 250 may be arranged in a two-dimensional array on the substrate 210. A black matrix 255 may be provided between two adjacent photodiodes 250. The photodiode 250 may serve to convert incident light into electrical energy, and a metal line (not shown) for detecting the electrical energy generated from the photodiode 250 may be provided on the substrate 210.

The color filter layer 260 may include a plurality of color filters 260R, 260G, and 260B provided to correspond to the plurality of photodiodes 250. The plurality of color filters 260R, 260G, and 260B may include, for example, a red color filter 260R, a green color filter 260G, and a blue color filter 260B. However, one or more embodiments are not limited thereto. A plurality of micro-lenses 270 corresponding to the plurality of color filters 260R, 260G, and 260B may be further provided on the color filter layer 260.

The amorphous boron nitride film 220 may be provided between the color filter layer 260 and the photodiodes 250. Here, the amorphous boron nitride film 220 may serve to limit and/or prevent reflection of light incident through the color filter layer 260 and may have a low refractive index and high hardness. Since the amorphous boron nitride film 220 has been described above, a description thereof will be omitted. Since the amorphous boron nitride film 220 is applied as an antireflection film in the image sensor 200, the light concentration of each of pixels may be improved, and light interference that may occur between pixels may be limited and/or prevented.

FIG. 12 is a schematic cross-sectional view of a structure of a semiconductor apparatus 600 including a interconnection structure according to an embodiment. Referring to FIG. 12, the semiconductor apparatus 600 may include a substrate 610 and a interconnection structure 620 provided on the substrate 610. The interconnection structure 620 may include a dielectric layer 622, a conductive line 624, and a diffusion barrier layer 626.

The substrate 610 may be a semiconductor substrate. For example, the substrate 610 may include a Group IV semiconductor material, a Group III-V compound semiconductor material, or a Group II-VI compound semiconductor material. For example, the substrate 610 may include at least one semiconductor material selected from Si, Ge, SiC, SiGe, SiGeC, a Ge alloy, GaAs, InAs, and InP. This is merely an example, and other various semiconductor materials may be used for a substrate. In addition, the substrate 610 may include a single layer or a plurality of layers in which different materials are stacked. For example, the substrate 610 may include a silicon-on-insulator (SOI) substrate or a silicon germanium-on-insulator (SGOT) substrate. In addition, at least one semiconductor device (not shown) may be included in the substrate 610. The semiconductor device may include, for example, at least one of a transistor, a capacitor, a diode, and a resistor.

The dielectric layer 622 may be formed on the substrate 610. The dielectric layer 622 may have a single-layer structure or a multi-layer structure in which different dielectric materials are stacked. The dielectric layer 622 may include a dielectric material used in a general semiconductor manufacturing process. For example, the dielectric layer 622 may include silicon oxide, silicon nitride, silicate, or the like. However, this is merely an example, and other dielectric materials may be used for the dielectric layer 622. In addition, the dielectric layer 622 may include a SiCOH-based organic-inorganic hybrid dielectric material. Furthermore, the dielectric layer 622 may include an amorphous boron nitride film according to embodiments. When the dielectric layer 622 includes the amorphous boron nitride film, the dielectric layer 622 may also perform a function of the diffusion barrier layer 626 to be escribed below. In this case, the diffusion barrier layer 626 to be described below may be omitted.

At least one trench 622a may be formed in the dielectric layer 622 to a certain depth. Here, at least one trench 622a may be formed not to be in contact with the substrate 610 or may be formed to be in contact the substrate 610. FIG. 12 illustrates two trenches 622a are formed in the dielectric layer 622 and illustrates a case in which, among the two trenches 622a, one trench 622a is formed not to be in contact with the substrate 610, and the other trench 622a is formed to be in contact with the substrate 610.

A conductive line 624 is provided to fill the inside of the trench 622a. The conductive line 624 may include a metal or metal alloy having excellent conductivity. For example, the conductive line 624 may include Cu, Ru, Al, Co, W, Mo, Ti, Ta, Ni, Pt, Cr, Rh, Ir, or an alloy thereof. However, one or more embodiments are not limited thereto, and various other metals may be used for the conductive line 624.

The diffusion barrier layer 626 may be provided on an inner wall of the trench 622a. Here, the diffusion barrier layer 626 may be provided between the dielectric layer 622 and the conductive line 624 to cover the conductive line 624. Specifically, the diffusion barrier layer 626 may be provided on the inner wall of the trench 622a to cover side surfaces and a lower surface of the conductive line 624. An upper surface of the conductive line 624 may be exposed by the diffusion barrier layer 626. The diffusion barrier layer 626 may serve to limit and/or prevent diffusion of a material constituting the conductive line 624. Meanwhile, the diffusion barrier layer 626 may additionally serve as an adhesive layer between the dielectric layer 622 and the conductive line 624. The diffusion barrier layer 626 may include an amorphous boron nitride film according to example embodiments.

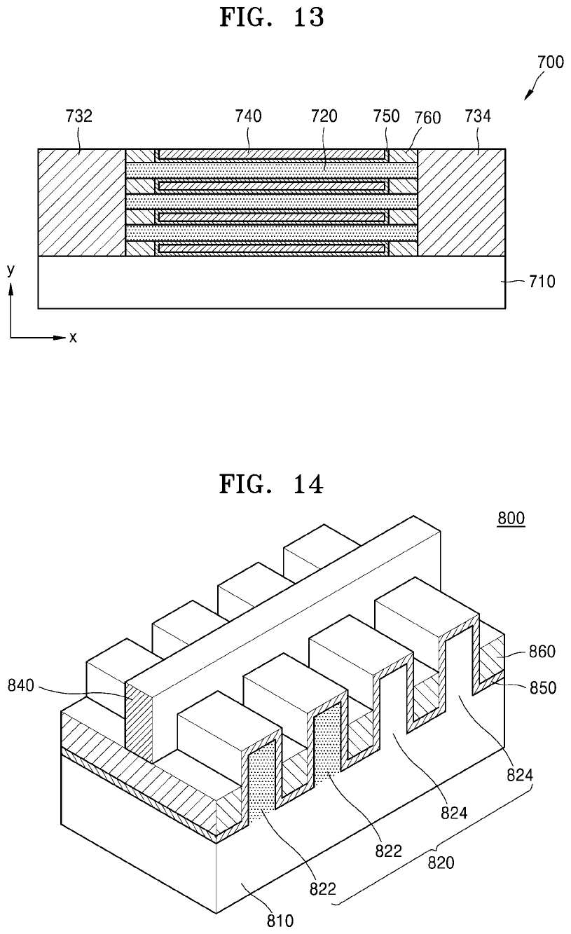

FIG. 13 is a schematic cross-sectional view of a structure of a field effect transistor 700 according to an embodiment. Referring to FIG. 13, the field effect transistor 700 may include a substrate 710, a plurality of channels 720 disposed on the substrate 710, a source 732 and a drain 734 which are each in contact with the channels 720, and a plurality of gates 740 spaced apart from the plurality of channels 720. The source 732 and the drain 734 may be spaced apart from each other in a first direction (that is, an X direction), and the plurality of channels 720 may be disposed between the source 732 and the drain 734 to be spaced apart from each other in a second direction (Y direction).

The plurality of gates 740 may be spaced apart from each other to face each other, and a gate insulating film 750 may be disposed between the gate 740 and the channel 720. For example, the gate insulating film 750 may be provided to cover at least a portion of the gate 740. For example, the gates 740 and the channels 720 may be alternately arranged in the second direction, and the gate insulating film 750 may surround the gate 740. The gate insulating film 750 insulates the channel 720 from the gate 740 and may suppress a leakage current.

Contact between each channel 720 and the source 732 and contact between each channel 720 and the drain 734 may have an edge contact shape. For example, both ends of the channel 720 may be in contact with the source 732 and the drain 734.

Each of the gates 740 may be spaced apart from the source 732 and the drain 734, and a spacer 760 may be further disposed between the gate 740 and the source 732 and between the gate 740 and the drain 734. Since the source 732, the gate 740, and the drain 734 are arranged in the first direction, parasitic capacitance may occur between the source 732 and the gate 740 and between the gate 740 and the drain 734.

In order to reduce the parasitic capacitance, the spacer 760 may include an amorphous boron nitride film according to embodiments. Since the amorphous boron nitride film according to the embodiments has a relatively low dielectric constant of about 1.5 to about 4.0 at an operating frequency of about 100 kHz, the parasitic capacitance may be effectively reduced. In addition, since the amorphous boron nitride film according to the embodiments has excellent mechanical properties, the spacer 760 may support the channel 720 disposed thereon.

The field effect transistor 700 may have a multi-bridge form in which the plurality of channels 720 each have both ends in contact with the source 732 and the drain 734 and are spaced apart from each other in a direction away from the substrate 710. A short channel effect may be reduced, and an area occupied by a source/drain may be reduced so that such a multi-bridge channel may be advantageous for high integration. In addition, since uniform source/drain junction capacitance may be maintained irrespective of a channel position, the field effect transistor 700 may be applied as a high-speed and high-reliability device.

The gate insulating film 750 may include a dielectric material having a relatively high dielectric constant. The gate insulating film 50 may include, for example, aluminum oxide, hafnium oxide, zirconium hafnium oxide, or lanthanum oxide. However, one or more embodiments are not limited thereto. Alternatively, the gate insulating film 750 may include a ferroelectric material. When the gate insulating film 750 includes the ferroelectric material, the field effect transistor 700 may be applied as, for example, a logic device or a memory device. Alternatively, the gate insulating film 750 may have a multi-layer structure including a high dielectric constant material and a ferroelectric material.

FIG. 14 is a schematic cross-sectional view of a structure of a field effect transistor 800 according to an embodiment. Referring to FIG. 14, the field effect transistor 800 may be a fin field effect transistor (FinFET) having a fin structure protruding from a substrate 810. Since the field effect transistor 800 may use protruding fin structures 822 and 824 as a channel 820, a sufficient channel length may be secured. Accordingly, a short channel effect may be limited or prevented or minimized, and leakage current generation and area problems may be improved.

The field effect transistor 800 may include the substrate 810, active fins 822, dummy fins 824, a gate 840, a gate insulating film 850, and a spacer 860. Although not shown in the drawing, both ends of the active fin 822 may be electrically connected to a source and a drain, respectively. Although two active fins 822 are shown as a channel, the number of active fins 822 is not limited thereto. The active fin 822 and the dummy fin 824 may be disposed to be connected to the substrate 810. In an embodiment, the active fin 822 may be an active region in which a portion protruding vertically from the substrate 810 is n+ or p+ doped, and the dummy fin 824 may be a region in which a protrude vertically from the substrate 810 is undoped. In another embodiment, both the active fin 822 and the dummy fin 824 may be n+ or p+ doped active regions. Each of the active fins 822 may have a width and a height, and the width and height of each of the active fins 822 may determine a width and a height of the channel 820. The width and height of the channel 820 may be increased according to the number of active fins 822.

The gate insulating film 850 may be disposed on the active fin 822 and the dummy fin 824. The gate insulating film 850 may include any one of an oxide layer, a nitride layer, and an oxynitride layer.

The spacer 860 may be disposed to have a certain height in a space between the active fin 822 and the dummy fin 824. The spacer 860 may include an amorphous boron nitride film according to example embodiments. Since the spacer 860 is disposed between the active fin 822 and the dummy fin 824, the spacer 860 may be used as a device isolation film and may reduce parasitic capacitance.

The gate 840 may be disposed on the gate insulating film 850 and the spacer 860. The gate 840 may have a structure surrounding the active fin 822, the dummy fin 824, and the spacer 860. In other words, the active fin 822 and the dummy fin 824 may have a structure disposed inside the gate 840.

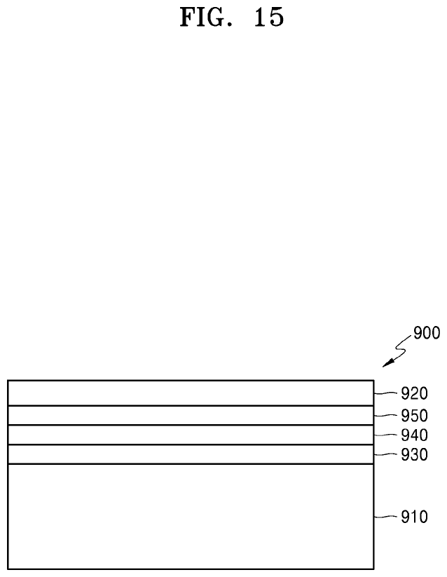

FIG. 15 is a view of a display device according to an embodiment.

Referring to FIG. 15, a display device 900 may include a display panel 910 and an amorphous boron nitride film 920 provided on the display panel 910. Although the display panel 910 may include, for example, a liquid crystal display panel, an organic light-emitting display panel, and the like, the disclosure is not limited thereto.

A transparent substrate 930 may be provided on an upper surface of the display panel 910, and a polarizer 940 for increasing a viewing angle may be provided on an upper surface of the transparent substrate 930. Furthermore, a protection film 950 may be provided on an upper surface of the polarizer 940. The amorphous boron nitride film 920 may be provided on an upper surface of the protection film 950 as an anti-reflection film. As the amorphous boron nitride film 920 is described above, a description thereof is omitted. The protection film 950 may include a material having a higher refractive index than the amorphous boron nitride film 920.

The above-described image sensor, semiconductor apparatus, and field effect transistors have been described with reference to the embodiment shown in the drawings, but these are merely examples, and those skilled in the art will appreciate that various modifications and other equivalent embodiments are possible from the embodiments.

A boron nitride compound according to an aspect of inventive concepts may be amorphous and may be doped with carbon or hydrogen at a certain concentration to improve thermal stability and mechanical stability so that the boron nitride compound may be applied to a thin film of an electronic device to increase the reliability of the device.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. An amorphous boron nitride compound, comprising:
a boron nitride compound, the boron nitride compound being amorphous and doped with carbon or hydrogen,
wherein a total content of the carbon or the hydrogen is in a range of about 0.1 at % to about 35 at % of a total atomic content in the boron nitride compound.

2. The amorphous boron nitride compound of claim 1, wherein
the boron nitride compound is doped with the carbon, and
a content of the carbon is in a range of about 10 at % to about 20 at % of a total atomic content of the boron nitride compound.

3. The amorphous boron nitride compound of claim 1, wherein
the boron nitride compound is doped with the carbon, and
the carbon participates in B—C bonds, N—C bonds, and C—C bonds.

4. The amorphous boron nitride compound of claim 3, wherein
in the boron nitride compound, a number of the B—C bonds is greater than a number of the N—C bonds and a number of the C—C bonds.

5. The amorphous boron nitride compound of claim 3, wherein a number of the B—C bonds is less than a number of the B—N bonds.

6. The amorphous boron nitride compound of claim 2, wherein a ratio of sp² bonding to sp³ bonding included in the boron nitride compound is in a range of about 2 to about 5.

7. The amorphous boron nitride compound of claim 2, wherein a ratio of sp² bonding to sp³ bonding included in the boron nitride compound is in a range of about 2 to about 3.

8. The amorphous boron nitride compound of claim 2, wherein an average coordination number of atoms in the boron nitride compound is in a range of about 2.92 to about 3.05.

9. The amorphous boron nitride compound of claim 2, wherein a diffusivity of atoms of the boron nitride compound is 1 Å²/ns or less at a temperature of about 2,000 K to about 2,500 K.

10. The amorphous boron nitride compound of claim 2, wherein a Young's modulus, a bulk modulus, and a shear modulus of the boron nitride compound are each independently in a range of about 110% to about 140% as compared with an other boron nitride compound that is not doped with carbon.

11. The amorphous boron nitride compound of claim 1, wherein
the boron nitride compound is doped with the hydrogen, and
a content of the hydrogen is in a range of about 5 at % to about 20 at % of a total atomic content of the boron nitride compound.

12. The amorphous boron nitride compound of claim 11, wherein a content of the hydrogen is in a range of about 8 at % to about 12 at % of a total atomic content.

13. The amorphous boron nitride compound of claim 11, wherein the hydrogen participates in B—H bonds, N—H bonds, and C—H bonds.

14. The amorphous boron nitride compound of claim 11, wherein a diffusivity of atoms of the boron nitride compound is 2 Å²/ns or less at a temperature of about 2,000 K to about 2,500 K.

15. The amorphous boron nitride compound of claim 11, wherein a Young's modulus, a bulk modulus, and a shear modulus of the boron nitride compound are each independently in a range of about 110% to about 140% as compared with an other boron nitride compound that is not doped with hydrogen.

16. A Boron nitride material comprising:
the amorphous boron nitride compound of claim 1.

17. A boron nitride film comprising:
the amorphous boron nitride compound of claim 1.

18. An electronic device comprising:
the boron nitride film of claim 17.

19. The electronic device of claim 18, wherein the boron nitride film is an interlayer insulating film, a diffusion barrier, a spacer, or a device isolation film.

20. The electronic device of claim 18, wherein the electronic device comprises a field effect transistor, a memory device, a display device, or an image sensor.
